(19) United States
(12) Patent Application Publication
(10) Pub. No.: US 2007/0106171 A1
(43) Pub. Date: May 10, 2007

(54) Detecting device for acupuncture meridian

(76) Inventor: Richad Li, Taichung (TW)

Correspondence Address: CHARLES E. BAXLEY, ESQ., 90 JOHN STREET, THIRD FLOOR, NEW YORK, NY, 10038, US

(21) Appl. No.: 11/253,950

(22) Filed: Oct. 18, 2005

(51) Int. Cl. A61H 39/02

(52) U.S. Cl. 600/548

(57) ABSTRACT

A detecting device includes a processor device, a sensor coupled to the processor device, and a probe coupled to the sensor for engaging with and for contacting with a skin of a human body. The probe includes a barrel having a compartment formed in the inner portion, and a cotton pad engaged with the compartment of the probe, for suitably engaging with and for contacting with the skin of the human body. The cotton pad is preferably made of squeezed cotton fibers which are preferably shaped or formed into a cylindrical structure, and having a uniform intensity for suitably engaging with the skin of the human body.

### BACKGROUND OF THE INVENTION

1. Field of the Invention

The present invention relates to a detecting device, and more particularly to a detecting device for detecting the energy of the human bodies via such as the acupuncture meridians of the human bodies, to detect and to determine the disorders or the diseases or the sicknesses of the internal organs of the human bodies, and thus to take the correct remedy to the disorders or the diseases or the sicknesses of the internal organs of the human bodies.

2. Description of the Prior Art

Typically, the internal organs are located within the human bodies and may not be easily detected whether the internal organs are disorder or sick or not. Accordingly, various kinds of expensive and complicated medical facilities have been developed for detecting and for treating the disorders or the diseases or the sicknesses of the internal organs of the human bodies.

In Chinese medicine, acupuncture technology have been developed for a long time, and comprise various kinds of meridians found in or on the human bodies, such as twelve divergent meridians, main meridians, muscle meridians, governing vessel meridians, conception vessel meridians, etc., in which some of the meridians are corresponded or related to the internal organs of the human bodies.

Some of the appliances or facilities have been developed for conducting or taking the remedy to treat the disorders or the diseases or the sicknesses of the internal organs of the human bodies. For example, U.S. Pat. No. 4,763,657 to Chen et al., and U.S. Pat. No. 5,107,832 to Guibert et al. discloses two of the acupuncture treating appliances or facilities, and comprises various conductors or threaded rods each being jacketed with a silicon-rubber sheath or an elastomeric cushioning material, for engaging with or for contacting with the outer skins of the human bodies.

Normally, electric pulses or signals or waves or the like are sent or transmitted to the conductors or threaded rods, for applying energy into the acupuncture points in the acupuncture meridians, in order to take the remedy to the disorders or the diseases or the sicknesses of the internal organs of the human bodies. However, the conductors or threaded rods are suitable for applying energy into the acupuncture points in the acupuncture meridians only, but may not be used to detect the energy or the changing of the acupuncture points in the acupuncture meridians of the human bodies.

The present invention has arisen to mitigate and/or obviate the afore-described disadvantages of the conventional detecting devices for acupuncture meridians.

### SUMMARY OF THE INVENTION

The primary objective of the present invention is to provide a detecting device for detecting the energy of the human bodies via such as the acupuncture meridians of the human bodies, to detect and to determine the disorders or the diseases or the sicknesses of the internal organs of the human bodies, and thus to take the correct remedy to the disorders or the diseases or the sicknesses of the internal organs of the human bodies.

In accordance with one aspect of the invention, there is provided a detecting device comprising a processor device, a sensor coupled to the processor device, a probe coupled to the sensor, the probe including a barrel having a compartment formed therein, and a cotton pad engaged with the compartment of the probe, for suitably engaging with and for contacting with a skin of a human body, and for obtaining precise or correct signals from the acupuncture meridians on the outer skin portions of the human body, for example. After the precise or correct signals are detected from the acupuncture meridians of the human body, the correct information of the disorders or the diseases or the sicknesses of the internal organs of the human bodies may thus be obtained, and thus the correct remedy may be taken to treat the disorders or the diseases or the sicknesses of the internal organs of the human bodies, with such as the cited conventional acupuncture treating appliances or facilities.

The cotton pad is preferably made of squeezed cotton fibers having a uniform intensity, and preferably shaped or formed into a cylindrical structure.

The probe includes a casing having a chamber formed therein, a conductor member having a stem slidably engaged into the chamber of the casing and having a shank extended therefrom for coupling to the barrel.

The conductor member includes an enlarged panel extended from the stem and having the shank extended therefrom, the enlarged panel is engageable with the barrel for anchoring and positioning the barrel to the conductor member.

The casing includes a spring member received therein and engaged with the stem of the conductor member, to bias and force the enlarged panel and the shank and the barrel to move away from the casing.

The conductor member includes a peripheral recess formed in the stem thereof, a housing includes a conductive core engaged therein and having an end engaged into the chamber of the casing and engaged with the peripheral recess of the stem, for limiting the stem of the conductor member to slide relative to the casing, and for preventing the conductor member from being disengaged from the casing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a detecting device in accordance with the present invention;

FIG. 2 is a partial exploded view of the detecting device; and

FIG. 3 is a partial cross sectional view of the detecting device, taken along lines 3-3 of FIG. 1, illustrating the inner structure of the detecting device.

### DETAILED DESCRIPTION OF THE PREFERRED EMBODIMENT

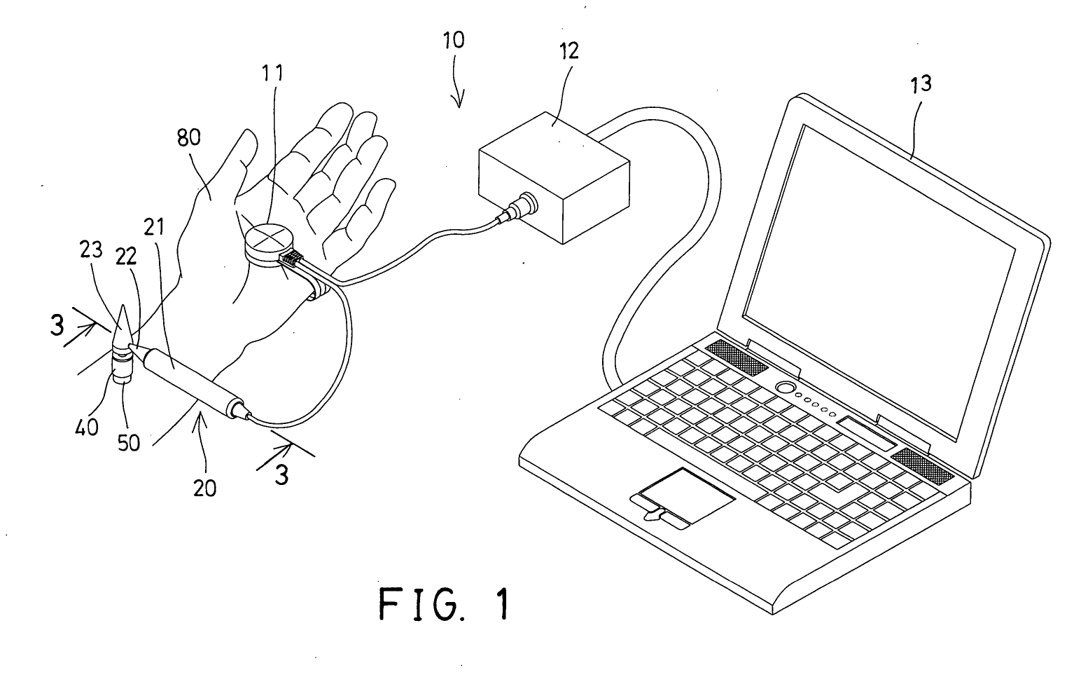

Referring to the drawings, and initially to FIG. 1, a detecting device 10 in accordance with the present invention comprises a sensor 11 for attaching to or for being held by a hand 80 of a user, and a switch box or transformer or processor device 12 or the like coupled to the sensor 11 for receiving and/or comparing and/or organizing and/or processing the signals from the sensor 11, and for sending or transmitting the processed signals to such as a computer facility 13.

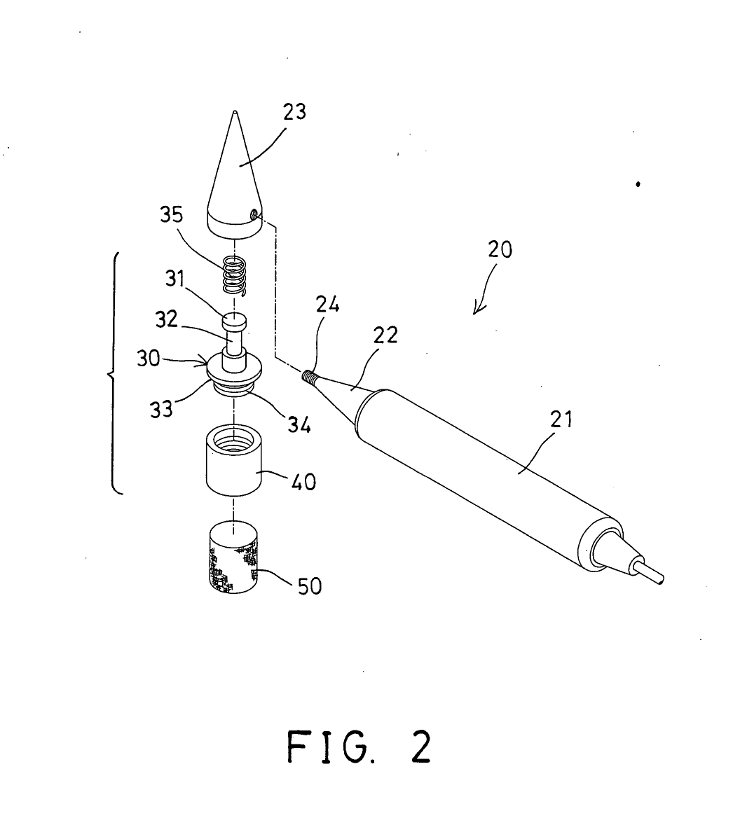

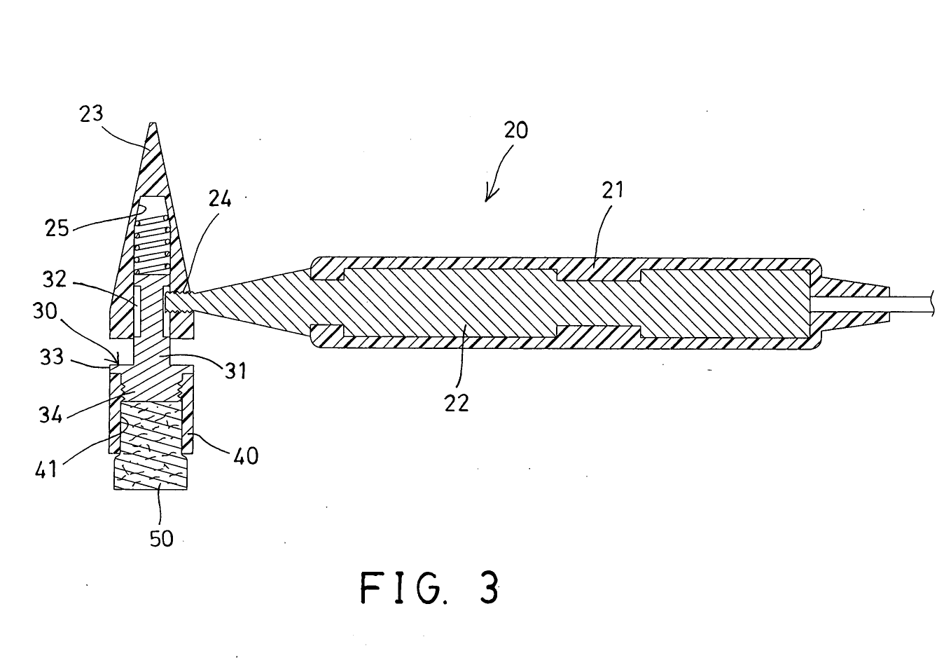

A probe 20 is then coupled to the sensor 11, for attaching to or for engaging with or for contacting with the outer skin portions of the human body. As shown in FIGS. 1-3, the probe 20 includes a handle or housing 21 having a conductive core 22 disposed or engaged therein, a casing 23 attached or secured to the conductive core 22 with such as a threaded engagement 24, or a threaded end 24 of the core 22, or the like, the casing 23 includes a chamber 25 formed therein (FIG. 3) for slidably receiving a conductor member 30 therein.

For example, the conductor member 30 includes a stem 31 extended therefrom and slidably engaged into the chamber 25 of the casing 23, and having a peripheral recess 32 formed therein. The end 24 of the conductive core 22 may be engaged into the chamber 25 of the casing 23, and engaged with the peripheral recess 32 of the stem 31, for limiting the stem 31 of the conductor member 30 to slide relative to the casing 23, and for preventing the conductor member 30 from being disengaged from the casing 23.

The conductor member 30 further includes an enlarged panel 33 radially extended outwardly from the stem 31, and a reduced threaded shank 34 further extended from the enlarged panel 33 for threading to a barrel 40. The enlarged panel 33 may be engageable with the barrel 40 for anchoring or positioning the barrel 40 to the conductor member 30. A spring member 35 may be received within the chamber 25 of the casing 23, and engaged with the stem 31 of the conductor member 30, to bias and to force the enlarged panel 33 and the threaded shank 34 and thus the barrel 40 to move out of or away from the casing 23.

As also shown in FIG. 3, the barrel 40 includes a space or compartment 41 formed therein for receiving a block or pad 50 which is provided for engaging with or for contacting with the outer skin portions of the human body, as shown in FIG. 1. The pad 50 is made of cotton fibers or cotton materials which may be molded or forged or shaped from a number layers of cotton sheet members, in order to form the cotton pad 50 having a substantially cylindrical shape or structure.

The thus formed or molded or forged cotton pad 50 may include the cotton fibers uniformly stacked or squeezed therein and having a suitable intensity, for allowing the cotton pad 50 to suitably engage with and contact with the outer skin portions of the human body, and for allowing uniform signals to be taken from the outer skin portions of the human body by the probe 20 via the uniform and intensity cotton pad 50, and thus to obtain precise or correct signals from the acupuncture meridians on the outer skin portions of the human body.

After the precise or correct signals are detected from the acupuncture meridians of the human body, the correct information of the disorders or the diseases or the sicknesses of the internal organs of the human bodies may thus be obtained, and thus the correct remedy may be taken to treat the disorders or the diseases or the sicknesses of the internal organs of the human bodies, with such as the cited conventional acupuncture treating appliances or facilities.

Accordingly, the detecting device in accordance with the present invention may be provided for detecting the energy of the human bodies via such as the acupuncture meridians of the human bodies, to detect and to determine the disorders or the diseases or the sicknesses of the internal organs of the human bodies, and thus to take the correct remedy to the disorders or the diseases or the sicknesses of the internal organs of the human bodies.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A detecting device comprising:
a processor device,
a sensor coupled to said processor device,
a probe coupled to said sensor, said probe including a barrel having a compartment formed therein, and
a cotton pad engaged with said compartment of said barrel, for engaging with and for contacting with a skin of a human body.

2. The detecting device as claimed in claim 1, wherein said cotton pad is made of squeezed cotton fibers having a uniform intensity.

3. The detecting device as claimed in claim 1, wherein said cotton pad includes a cylindrical structure.

4. The detecting device as claimed in claim 1, wherein said probe includes a casing having a chamber formed therein, a conductor member having a stem slidably engaged into said chamber of said casing and having a shank extended therefrom for coupling to said barrel.

5. The detecting device as claimed in claim 4, wherein said conductor member includes an enlarged panel extended from said stem and having said shank extended therefrom, said enlarged panel is engageable with said barrel for anchoring and positioning said barrel to said conductor member.

6. The detecting device as claimed in claim 4, wherein said casing includes a spring member received therein and engaged with said stem of said conductor member, to bias and force said enlarged panel and said shank and said barrel to move away from said casing.

7. The detecting device as claimed in claim 4, wherein said conductor member includes a peripheral recess formed in said stem thereof, a housing includes a conductive core engaged therein and having an end engaged into said chamber of said casing and engaged with said peripheral recess of said stem, for limiting said stem of said conductor member to slide relative to said casing, and for preventing said conductor member from being disengaged from said casing.
